(19) United States
(12) Patent Application Publication
(10) Pub. No.: US 2025/0392653 A1
(43) Pub. Date: Dec. 25, 2025

(54) DECODE VARIABLE LENGTH RANGES

(71) Applicant: Advanced Micro Devices, Inc., Santa Clara, CA (US)

(72) Inventor: Nicolai Haehnle, Polling (DE)

(21) Appl. No.: 18/752,476

(22) Filed: Jun. 24, 2024

(51) Int. Cl. H04L 69/22; H04L 69/18

(52) U.S. Cl. CPC H04L 69/22; H04L 69/18

(57) ABSTRACT

An apparatus and method for efficiently performing data decoding in an integrated circuit. A computing system includes a processing circuit and a memory that stores multiple data streams. Each of the data streams is partitioned into multiple, same-sized sectors. The data stream stores multiple variable length packets, each aligned on a boundary of a sector. The processing circuit uses a parallel data microarchitecture to perform parallel data decoding and generate a mask specifying which sectors of the data stream store the start of a data packet and the number of data packets in the data stream. One or more vector instructions are available to the computer programmer to process data streams using parallel decoding. The mask supports parallel data processing for the next stage of data processing of the application.

### BACKGROUND

### Description of the Relevant Art

Processing instruction streams in a computing system where the data (e.g., packets) are variable in length can be difficult and time consuming. For example, you typically have to be able to identify headers and analyze the content to identify the payloads and their size. This may generally require processing the data in a serial manner so that the locations (start and end) of data can be determined. Often, the information is prepared as a data stream for transmission that includes a bit stream or a byte stream in a point-to-point interconnection. A receiver divides the received data stream into multiple same-sized sectors. However, the packets inserted in the data stream and distributed across the multiple sectors can vary in size. The varying sizes of the packets can be due to packets of different types being placed in the data stream and it is possible that different sources generated the packets being placed in the data stream.

Typically, each of the varying sized packets includes a header, an opcode, or other section at the start of the packets with control information used to specify the size of the corresponding packet. The size of the packet can also be referred to as the length of the packet. To reduce complexity of decoding the data stream with variable length packets, during insertion of packets into the data stream the packets are aligned on a sector boundary, such as a byte boundary or a boundary of another size. However, the location within the data stream of the headers of the variable length packets are unknown and can change from data stream to data stream. Consequently, decoding these data streams is done in a serial manner to find the start location and end location of each variable length packet in the data stream. Serially decoding the data stream increases latency and reduces performance.

In view of the above, efficient methods and apparatuses for efficiently performing data decoding in an integrated circuit are desired.

### BRIEF DESCRIPTION OF THE DRAWINGS

FIG. 1 is a generalized diagram of a packet receiver that efficiently performs data decoding in an integrated circuit.

FIG. 2 is a generalized diagram of packet decoding that supports efficient data transfer in an integrated circuit.

FIG. 3 is a generalized diagram of packet decoding that supports efficient data decoding in an integrated circuit.

FIG. 4 is a generalized diagram of an apparatus that efficiently performs data decoding in an integrated circuit.

FIG. 5 is a generalized diagram of a computing system that efficiently performs data decoding in an integrated circuit.

FIG. 6 is a generalized diagram of a method for efficiently performing data decoding in an integrated circuit.

FIG. 7 is a generalized diagram of a method for efficiently performing data decoding in an integrated circuit.

FIG. 8 is a generalized diagram of a method for efficiently performing data decoding in an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently decoding data in a computing system are disclosed. In various implementations, a computing system includes a parallel data processing circuit and a memory that stores multiple data streams. Each of the data streams stores multiple variable length packets. Each of the packets is one of a variety of data types, such as a network packet of multiple variable length network packets, an instruction of multiple variable length instructions of an instruction stream, a code word of multiple variable length code words generated by an encoding algorithm, or otherwise. The start of each of the variable length packets includes header information, an opcode, or other indication specifying the length of a corresponding data packet. However, the number of variable length data packets within the data streams and the locations of the beginnings of the variable length packets within the data stream are initially unknown. Rather than serially processing the data streams to locate the multiple variable length packets within the data stream and specifying the number of the packets within the data streams, the processing data processing circuit is configured to perform parallel decoding of the data streams. Parallel decoding reduces the latency of processing the data streams, which increases performance.

The parallel data processing circuit uses a parallel data microarchitecture such as a single instruction multiple data (SIMD) parallel microarchitecture. The parallel data processing circuit includes one or more vector processing circuits, each with multiple, parallel lanes of execution. The parallel data processing circuit partitions each of the data streams into multiple sectors with each sector having the same data size. In an implementation, the data size of the sectors is a byte (8 bits). In other implementations, the data size is two bytes, a word (four bytes), or other. The data size is based on design requirements of the computing system using the packet receiver. Each of the multiple variable length packets is aligned on a boundary of a sector. Each of the multiple, parallel lanes receives a corresponding sector of the data stream and concurrently processes the data as other lanes in the same clock cycle in a lockstep manner. As used herein, processing data in a “lockstep manner” refers to the multiple lanes of execution both starting the data processing in a same first clock cycle (or pipeline stage) and completing the data processing in a same second clock cycle (or pipeline stage). When the latency of the data processing is a single clock cycle, the starting clock cycle is the same as the completing clock cycle.

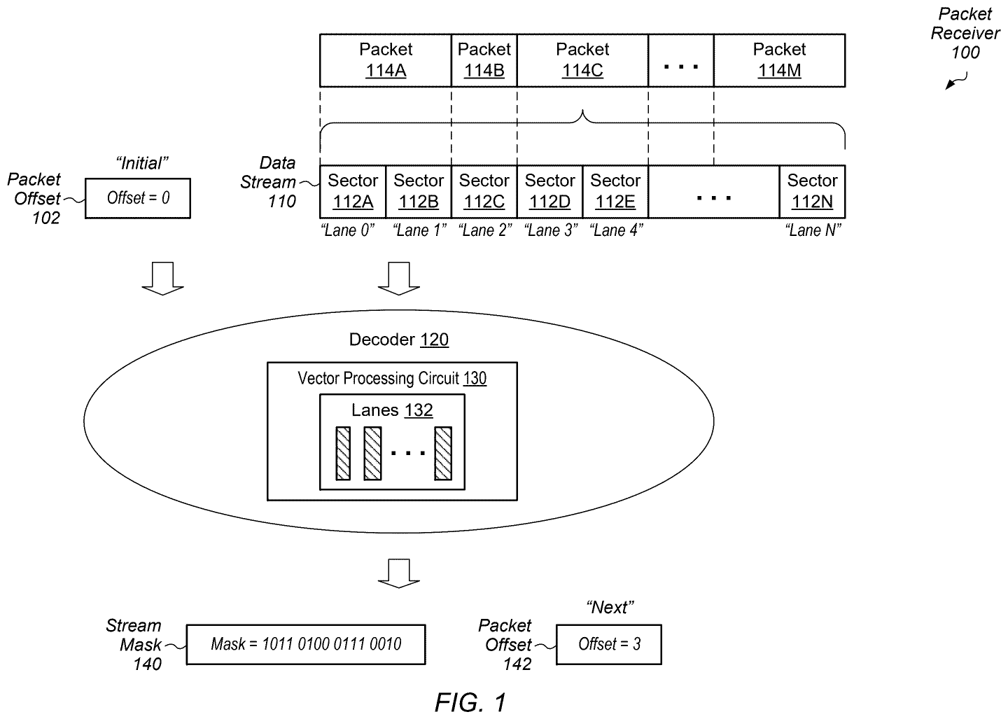

The parallel data processing circuit receives an instruction or other indication specifying to decode a data stream. Using the lanes of execution, the parallel data processing circuit generates a bit mask with each bit specifying whether a corresponding sector of the multiple sectors stores the start of a data packet. A first (most-significant) bit of the bit mask specifies whether the first (most-significant) sector of the multiple sectors stores the start of a data packet. The second contiguous bit of the bit mask specifies whether the second contiguous sector of the multiple sectors stores the start of a data packet, and so on. Therefore, the bit mask also indicates the number of variable length packets within the data stream and the locations of the variable length packets within the data stream. In various implementations, one or more vector decode instructions are available to the computer programmer to process data streams using parallel decoding. The bit mask generated by the one or more vector decode instructions is sent to the next stage of data processing of the application written by the computer programmer. The bit mask supports parallel data processing for the next stage of data processing of the application, which reduces latencies and increases performance. Further details of these techniques that efficiently perform data transfer in an integrated circuit are provided in the following description of FIGS. 1-8.

Referring to FIG. 1, a generalized block diagram of one implementation of a packet receiver 100 that efficiently performs data decoding in an integrated circuit is shown. In the illustrated implementation, packet receiver 100 includes decoder 120 that receives a data stream 110 and a packet offset 102. With the received information, decoder 120 generates the stream mask 140 and the packet offset 142. Queues for storing input information and output information are not shown for ease of illustration. As shown, data stream 110 is divided into multiple same-sized sectors 112A-112N. The size of the sectors 112A-112N is chosen based on design requirements. An example of the size of the sectors 112A-112N is a byte (8 bits). The number of sectors 112A-112N included in data stream 110 can be any number based on design requirements. Multiple variable length packets 114A-114M are inserted in data stream 110 and distributed across the sectors 112A-112N.

In various implementations, each of packets 114A-114M is aligned on a boundary of the sectors 112A-112N as shown by the vertical dashed lines. In some implementations, two or more of the packets 114A-114M have the same data size, but one or more packets of packets 114A-114M have a different size from other packets of packets 114A-114M. As shown, packet 114A has a size of two sectors (sectors 112A and 112B), packet 114B has a size of one sector (sector 112C), and so forth. In various implementations, packet receiver 100 receives data stream 110 and the packet offset 102 because of a processing circuit using packet receiver 100 is executing a vector decode instruction. In some implementations, the vector decode instruction includes a source operand that includes a pointer or an address, or a vector register identifier (ID) that specifies a data storage location that stores the data stream 110. The vector decode instruction also includes a scalar data input source operand such as packet offset 102. The vector decode instruction also includes a destination operand that includes a pointer or an address, or a vector register ID that specifies a data storage location that stores stream mask 140. The vector decode instruction also includes a scalar data output destination operand such as packet offset 142. The stream mask 140 is a bit mask that indicates the number of variable length packets 114A-114M within the data stream 110 and the locations of the variable length packets 114A-114M within the data stream 110.

In some implementations, packet receiver 100 receives data stream 110 from a communication fabric router or switch via a fabric link and the data stream 110 is a link packet. Data stream 110 has sufficient data storage space for storing two or more fabric transport interface packets. In another implementation, packet receiver 100 directly receives data stream 110 from a processing circuit, a peripheral device, or another type of transmitter via a point-to-point interconnection. Other types of sources of the data stream 110 and other types of communication paths are possible and contemplated. A variety of data types are transported by packets 114A-114M. Examples of the data types being transported by packets 114A-114M are instructions of a software application, memory access read/write requests, memory access responses, probe requests or responses, token or credit requests or responses, messages, audio or video control information, audio, or video payload information, and so on. The type, sizes, and number of the packets 114A-114M placed in data stream 110 are based on design requirements of the corresponding computing system using packet receiver 100.

In an implementation, decoder 120 receives data stream 110 in a single clock cycle. In other implementations, decoder 120 receives data stream 110 over multiple clock cycles. In some implementations, the number of clock cycles is predetermined. In various implementations, data stream 110 does not include metadata or other control information storing an indication of which one(s) of the sectors 112A-112N store the start of a packet of the variable length packets 114A-114M. In some implementations, each of the sectors 112A-112N is allocated, but which sector is the first sector (or most-significant sector) that stores the beginning of a variable length packet of packets 114A-114M is initially unknown to packet receiver 100. In the illustrated implementation, sector 112A is the first sector (or most-significant sector) that stores the beginning of a variable length packet of packets 114A-114M, since packet 114A is the first packet (or most-significant packet) of packets 114A-114M. Sector 112C is the second sector that stores the beginning of a variable length packet of packets 114A-114M, and sector 112 D is the third sector that stores the beginning of a variable length packet of packets 114A-114M. However, upon receiving data stream 110 and prior to decoding, packet receiver 100 is unaware of which sectors of sectors 112A-112N are sectors that store the beginning of packets 114A-114M. To aid packet receiver 100, the packet offset 102 accompanies data stream 110.

Decoder 120 also receives packet offset 102, which stores an initial packet offset specifying which sector of sectors 112A-112N is the first sector (or most-significant sector) that stores the beginning of a packet of variable length packets 114A-114M. In various implementations, decoder 120 generates packet offset 142 based on decoding data stream 110, and uses packet offset 142 as the input packet offset 102 for a subsequent data stream. In an implementation, decoder or other external circuitry receives an indication (not shown) that new information is being sent for decoding. The new information includes one or more data streams. It is known that the initial packet offset is zero, or otherwise indicates that the first or most-significant sector of sectors 112A-112N stores the beginning of the first packet of variable length packets 114A-114M. Subsequent data streams can store the beginning of the first packet of variable length packets 114A-114M in another sector other than sector 112A of sectors 112A-112N.

In some implementations, decoder 120 processes data stream 110 by generating stream mask 140 and packet offset 142. Stream mask 140 stores an asserted bit in a particular bit position specifying which sectors of sectors 112A-112N store the beginning of one of the variable length packets 114A-114M. Therefore, stream mask 140, which is a bit mask in some implementations, also indicates the number of variable length packets 114A-114M within the data stream 110 and the locations of the variable length packets 114A-114M within the data stream 110. For example, each of the vertical dashed lines indicates the beginning of a corresponding packet of packets 114A-114M. The stream mask 140 supports parallel data processing for the next stage of data processing, which reduces latencies and increases performance. An asserted bit is a Boolean logic high value (bit value ‘1’) in some implementations, but the asserted bit is a Boolean logic low value (bit value ‘0’) in other implementations. Packet receiver 100 sends data stream 110, packet offset 142, and stream mask 140 to further external decoding circuitry or another type of circuitry that processes data stream 110 based on information stored in stream mask 140. The use of stream mask 140 and packet offset 142 supports further parallel processing of data stream 110.

In an implementation, decoder 120 includes vector processing circuit 130. Although a single vector processing circuit is shown, decoder 120 can include any number of vector processing circuits based on design requirements. Vector processing circuit 130, or single instruction multiple data (SIMD) circuit 130, includes multiple parallel lanes 132 of execution. Tasks can be executed in parallel by being sent to parallel data processing circuits, such as vector processing circuit 130, to increase the throughput of the computing system. It is noted these parallel data processing circuits can also be referred to herein as “stream processing circuits.”

Each lane (or execution lane) of lanes 132 is also referred to as a single instruction multiple data (SIMD) lane. The hardware, such as circuitry, of each of lanes 132 is an instantiation of other lanes of lanes 132. The components in lanes 132 operate in lockstep. In various implementations, the data flow within each of the lanes 132 is pipelined. Pipeline registers are used for storing intermediate results. Within a given row across lanes 132, a vector arithmetic logic unit (ALU) includes the same circuitry and functionality, and operates on the same instruction, but different data associated with a different thread. Although not shown, the vector ALU can include a variety of other types of execution circuits such as a comparator circuit, a norm functional circuit, a rounding functional circuit, a clamping circuit, a divider circuit, a square root function circuit, and so forth. The vector ALU can also include circuitry that supports a variety of mathematical operations such as integer mathematical operations, Boolean bit-wise operations, and floating-point mathematical operations.

In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by a compute circuit (not shown) can be grouped into a “workgroup” that includes multiple thread groups (or multiple wavefronts). The hardware, such as circuitry, of a scheduler schedules a workgroup to a compute circuit and divides the workgroup into separate thread groups (or separate wavefronts). The scheduler assigns the thread groups (wavefronts) to separate vector processing circuits such as vector processing circuit 130. In some implementations, the multiple instantiations of execution lanes 132 of vector processing circuit 130 are used in a parallel data processing circuit such as a graphics processing unit (GPU), a digital signal processor (DSP), a field programmable gate array (FPGA), or otherwise. Parallel data processing circuits are efficient for data parallel computing found within loops of applications, such as in applications for computer and mobile device display graphics, molecular dynamics simulations, deep learning training, finance computations, and so forth.

In various implementations, each of the lanes 132 receives a sector of sectors 112A-112N and decodes the received sector. In an implementation, lane 0 of lanes 132 receives sector 112A (sector 0), lane 1 of lanes 132 receives sector 112B (sector 1), lane 2 of lanes 132 receives sector 112C (sector 2), and so forth. Each of lanes 132 decodes a corresponding assigned sector of sectors 112A-112N to generate an offset that specifies a subsequent sector that stores a start of a packet of packets 114A-114M. Each of lanes 132 generates these offsets concurrently. For example, in various implementations, each of the lanes 132 is configured to generate an offset in the same clock cycle.

To decode a sector, (e.g., sector 112C, sector 2), the circuitry of lane 2 of lanes 132 parses the data of sector 112C into one or more fields and converts (or maps) at least one of the one or more fields into separate data values. In various implementations, it is known based on the type of computing system using packet receiver 100 and the type and available sizes of packets 114A-114M which field of the one or more fields stores an indication that when decoded specifies a data size of a corresponding packet (packet 114B). In one implementation, one or more of the packets 114A-114M is an instruction of multiple variable length instructions of an instruction stream. The one or more sectors of sectors 112A-112N that store the beginning of an instruction stores the opcode of the corresponding instruction. When decoded, the opcode includes information such as the number of operands, the sizes of the operands, the size of any immediate data field, the size of any payload data, and so forth. Lanes 132 decode the sectors 112A-112N as if each of the sectors 112A-112N includes an opcode, although one or more of the sectors 112A-112N store a remaining portion of a variable length instruction, rather than an opcode. Afterward, lanes 132 generate the data sizes of packets 114A-114M and then calculate the offsets based on the data sizes as further described below.

In another implementation, one or more of the packets 114A-114M is a code word of multiple variable length code words generated by an encoding algorithm. In various implementations, a code word is a distinct code word if each codeword is distinguishable from every other code word. In other words, each source value or message has a one-to-one mapping with a corresponding code word. The encoding algorithm also uses uniquely decodable code words when each distinct code word is identifiable within a sequence of code words. In other words, no distinct code word is a prefix of any other distinct code word. The computing system that uses packet receiver 100 is aware of the range of sizes of the distinct code words. Further, if the encoding algorithm uses a fixed-size minimal prefix code for each of the code words that indicates a size of the corresponding code word, then in an implementation, each of the sectors 112A-112N has the size of the fixed-size minimal prefix code. The fixed-size minimal prefix code can be treated as an opcode that indicates how many more sectors are used for the corresponding code word, if any. Lanes 132 decode the sectors 112A-112N as if each of the sectors 112A-112N includes the fixed-size minimal prefix code, although one or more of the sectors 112A-112N store a remaining portion of a variable length code word, rather than the fixed-size minimal prefix code. Afterward, lanes 132 generate the data sizes of packets 114A-114M and then calculate the offsets based on the data sizes as further described below.

In yet another implementation, one or more of the packets 114A-114M is a variable length communication packet that supports a communication protocol used by the computing system that includes packet receiver 100. The one or more sectors of sectors 112A-112N that store the beginning of a communication packet store header information that includes one or more fields. Packet receiver 100 is aware of the sizes and locations of these fields of the header information. In some implementations, the header information includes a transaction type (e.g., write request, read request, snoop request, token update command, other types of commands), a source identifier, a destination identifier, a quality-of-service (QOS) parameter, and so forth. In an implementation, the size of the communication packet can also be specified. The field that stores the packet size can be located a fixed number of bits from the most-significant bit of the header information. In another implementation, two or more fields are decoded to generate the packet size. For example, the first field indicates a write request and a second field indicates a size of the write data payload. Lanes 132 decode the sectors 112A-112N as if each of the sectors 112A-112N includes header information, although one or more of the sectors 112A-112N store a remaining portion of a variable length communication packet, rather than header information. Afterward, lanes 132 generate the data sizes of packets 114A-114M and then calculate the offsets based on the data sizes as further described below.

In an implementation, lane 0 can subtract one from the ratio of the data size of packet 114A and the size of each of the sectors 112A-112N to generate the corresponding offset. For example, the size of packet 114A is two sectors. Therefore, lane 0 calculates that the offset for sector 112A is 1, or ((2 sectors/1 sector)−1). There is one sector between the beginning of packet 114A and the beginning of packet 114B. The size of packet 114B is one sector. Therefore, lane 2 calculates that the offset for sector 112C is 0, or ((1 sector/1 sector)−1). There are no sectors between the beginning of packet 114B and the beginning of packet 114C. Other definitions and indications of the offset are possible and contemplated. It is noted that the generated offset can be inaccurate since it is possible that the corresponding sector does not actually store a start of a packet of packets 114A-114M. For example, lane 4 of lanes 132 decodes sector 112E (sector 4), and sector 112E stores the second half of packet 114C, not the beginning of packet 114C. Lane 4 still decodes sector 112E in a lockstep manner with the other lanes of lanes 132 and generates an offset. However, packet receiver 100 generates the stream mask 140 to indicate that the offset for sector 112E is an invalid value. When packet receiver 100 generates the stream mask 140, the validity of the offsets generated by lanes 132 become known as further discussed below.

Each of lanes 132 generates an indication specifying whether the received corresponding sector stores the beginning of a packet of packets 114A-114M. Each of lanes 132 generates these indications concurrently in the same clock cycle in a lockstep manner. Prior to storing data in mask stream 140, vector processing circuit 130 uses packet offset 102 to qualify the indications generated by lanes 132. For lanes of lanes 132 less than the lane specified by packet offset 102, no beginnings (or headers of packets or opcodes of instructions) of packets 114A-114M should be specified. Therefore, the corresponding sectors do not store the beginnings (or headers of packets or opcodes of instruction packets) of packets 114A-114M. If any of the corresponding lanes of lanes 132 generated an indication specifying the beginning of a packet has been found, the indication is disqualified, and a negated value is stored in stream mask 140 in a corresponding bit position.

For the lane of lanes 132 specified by packet offset 102, a beginning (or header of packet or opcode of instruction packet) of packets 114A-114M should be specified. Therefore, the corresponding sector does store the beginning of a packet of packets 114A-114M, and the indication of this lane is qualified. A corresponding asserted value is stored in stream mask 140 in a corresponding bit position. For lanes of lanes 132 greater than the lane specified by packet offset 102, further steps are performed to generate an indication specifying whether the corresponding sector of sectors 112A-112N stores a start or beginning of a packet of packets 114A-114M based on indications of previous sectors of sectors 112A-112N of data stream 110.

As described earlier, in some implementations, packet receiver 100 sends both data stream 110 and stream mask 140 to further external decoding circuitry that processes data stream 110 based on information stored in stream mask 140. The further decoding circuitry can be located in another stage of packet receiver 100 or located in another processing circuit or other component. In other implementations, packet receiver 100 removes each packet of packets 114A-114M from data stream 110 based on stream mask 140 and sends the individual packets to queue entries of one or more queues for later further processing. In an implementation, packet receiver 100 uses a credit or token subsystem for controlling the rate of input data and output data when decoding data streams. The credit or token updates are based on the rate of receiving data streams, the rate of processing data streams, and the number of packets found in data streams.

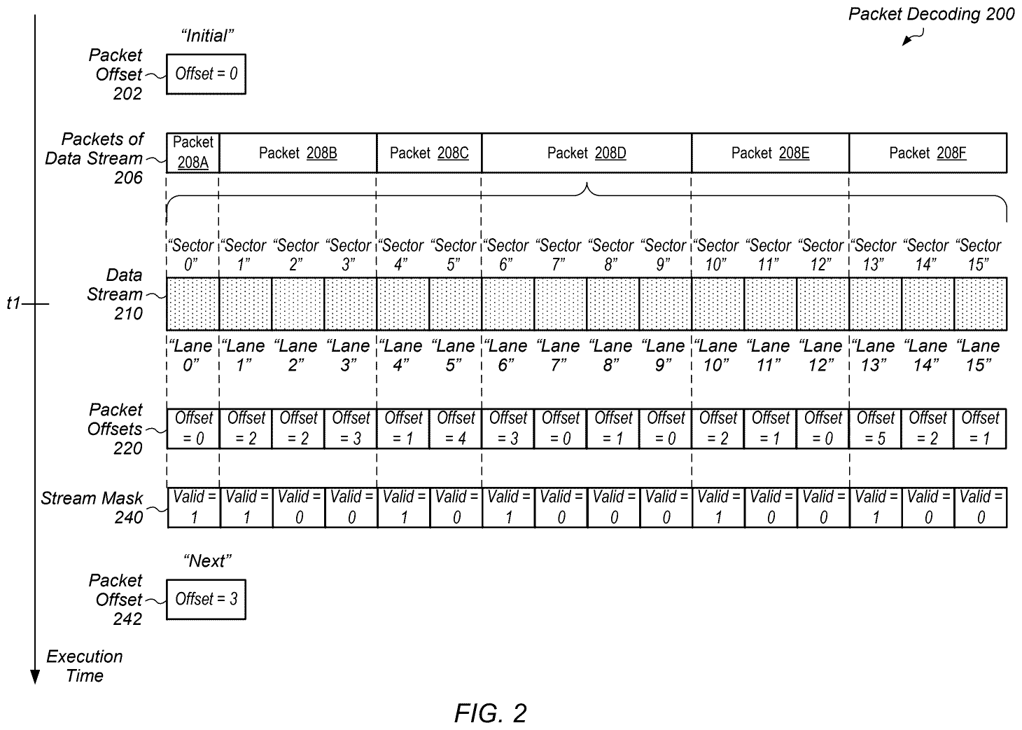

Referring to FIG. 2, a generalized diagram is shown of packet decoding 200 in an integrated circuit. As shown, a packet receiver receives a packet offset 202 and data stream 210 at point in time t1. The packets of data stream 210 are shown as packets of data stream 206. Packets of data stream 206 includes packets 208A-208F. The start of each of the variable length packets 208A-208F includes header information, an opcode, or other indication specifying the length of a corresponding one of the variable length packets 208A-208F. However, the number of packets in the variable length packets 208A-208F and the locations of the beginnings of the variable length packets 208A-208F are initially unknown. In the illustrated implementation, data stream 210 includes 16 sectors although another number of sectors is used in other implementations. In an implementation, each one of the multiple sectors has a size of one byte (8 bits). In other implementations, the data size is two bytes, a word (four bytes), or other. The data size is based on design requirements of the computing system using the packet receiver 200.

In various implementations, each of packets 208A-208F is aligned on a boundary of the sectors as shown by the vertical dashed lines. In an implementation, each of the packets 208A-208F is a communication packet, and a first (most-significant) sector stores information that can be used to generate the total data size of the packet. In this implementation, the 4 most-significant bits are used to indicate the transaction type of the communication packet followed by 7 contiguous bits used to indicate the payload data size. Each header of the packets 208A-208F has a size of 3 bytes and the payload data is placed contiguously next to the header in the packet. The corresponding lane of multiple, parallel execution lanes of a vector processing circuit (not shown) inspects the 7 bits following the 4 most-significant bits indicating the transaction type.

The corresponding lane decodes the payload data size using these 7 bits and adds the payload data size indicated by the 7 bits (a payload of 16 bytes) to the 3 bytes of the header. This sum provides the total data size of the communication packet. In this case, the total data size is 19 bytes (3 bytes for the header+16 bytes of payload data). However, the alignment of the sectors should be on a minimum 2-byte boundary to ensure the 7 bits of size information are always placed in the same sector. Padding can be used at the end of packets to ensure packets are aligned on a boundary of the sectors. It is possible and contemplated that other data arrangements and fields are used in other types of communication packets. However, the communication packets are aligned on the boundaries of the sectors with the selected size and the first (most-significant) sector stores information to use to calculate the total data size of the corresponding packet.

In another implementation, each of the packets 208A-208F is an instruction of an instruction stream, and a first (most-significant) sector stores an opcode with a size of 6 bits. The opcode can be used to generate the total data size of the packet (instruction). The opcode includes information such as the number of operands, the sizes of the operands, the size of any immediate data field, the size of any payload data, and so forth. The alignment of the sectors should be on a minimum 1-byte boundary to ensure the 6 bits of size information (opcode) are always placed in the same sector. Padding can be used at the end of packets (instructions) to ensure packets are aligned on a boundary of the sectors. Packets of data stream 206 include six packets 208A-208F, but another number of packets are used in other implementations. As described earlier, this number of packets of the variable length packets 208A-208F is initially unknown to the packet receiver.

The packet receiver sends each of the sectors of data stream 210 to a corresponding lane of multiple, parallel execution lanes of a vector processing circuit (not shown). In various implementations, this vector processing circuit has the same functionality as vector processing circuit 130. Each of the lanes decodes the received corresponding sector and generates an indication specifying an offset of packet offsets 220. In various implementations, each of packet offsets 220 specifies a location of the beginning of a subsequent packet in data stream 210. The vertical dashed lines indicate the beginnings of packets 208A-208F at time t1.

In an implementation, each one of packet offsets 220 specifies the number of contiguous sectors to skip to locate the sector that stores the start of the subsequent packet in data stream 210. In another implementation, each of the packet offsets 220 specifies the number of contiguous sectors to add to the corresponding lane identifier to locate the lane and corresponding sector that stores the start of the subsequent packet in data stream 210. In such an implementation, each of packet offsets 220 shown in FIG. 2 would be incremented by one. In other implementations, other values are used for packet offsets 220 for specifying the location of the sector that stores the start of the subsequent packet in data stream 210. Each of the multiple, parallel lanes generates these indications concurrently in the same clock cycle in a lockstep manner.

Prior to storing data in stream mask 240, the packet receiver uses packet offset 202 to qualify the packet offsets 220 generated by the multiple, parallel lanes. In the illustrated implementation, packet offset 202 indicates that the first sector (or most-significant sector) of data stream 210 being processed by “Lane 0” of the vector processing circuit stores the start (or beginning) of a packet, such as packet 208A, in data stream 210. Therefore, the corresponding first bit position (“Lane 0”) of stream mask 240 is written with an asserted bit. Additionally, the corresponding packet offset of “0” for “Lane 0” of packet offsets 220 is considered valid. This packet offset of “0” indicates that there are no intermediate sectors between the starting sector of packet 208A and the starting sector of the subsequent packet. Consequently, the second sector of data stream 210 being processed by “Lane 1” of the vector processing circuit stores the start (or beginning) of another packet, such as packet 208B, in data stream 210. The corresponding second bit position (“Lane 1”) of stream mask 240 is written with an asserted bit. The corresponding packet offset of “2” for “Lane 1” of packet offsets 220 is considered valid. This packet offset of “2” indicates that there are two intermediate sectors between the starting sector of packet 208B and the starting sector of the subsequent packet. Therefore, the fifth sector of data stream 210 being processed by “Lane 4” of the vector processing circuit stores the start (or beginning) of another packet, such as packet 208C, in data stream 210. The corresponding fifth bit position (“Lane 4”) of stream mask 240 is written with an asserted bit. The corresponding third bit position (“Lane 2”) and fourth bit position (“Lane 3”) of stream mask 240 are written with a negated bit.

The packet offset of “1” for “Lane 4” indicates that there is one intermediate sector between the starting sector of packet 208C and the starting sector of the subsequent packet. Accordingly, the seventh sector of data stream 210 being processed by “Lane 6” of the vector processing circuit stores the start (or beginning) of another packet, such as packet 208D, in data stream 210. The corresponding seventh bit position (“Lane 6”) of stream mask 240 is written with an asserted bit. The corresponding sixth bit position (“Lane 5”) of stream mask 240 is written with a negated bit. The corresponding packet offset of “3” for “Lane 6” of packet offsets 220 is considered valid. This packet offset of “3” for “Lane 6” indicates that there are three intermediate sectors between the starting sector of packet 208D and the starting sector of the subsequent packet. Therefore, the eleventh sector of data stream 210 being processed by “Lane 10” of the vector processing circuit stores the start (or beginning) of another packet, such as packet 208E, in data stream 210. The corresponding eleventh bit position (“Lane 10”) of stream mask 240 is written with an asserted bit. The corresponding eighth bit position (“Lane 7”), the ninth bit position (“Lane 8”), and tenth bit position (“Lane 9”) of stream mask 240 are written with a negated bit.

The above processing steps continue for the remaining sectors of data stream 210 and the results are shown. It is noted that offsets of packet offsets 220 are ignored for bit positions of stream mask 240 that store a negated bit. For example, the packet offset of “2” for “Lane 14” of packet offsets 220 is considered invalid and this packet offset is ignored. For the last sector storing the start of a packet of data stream 210, the corresponding packet offset of “5” for “Lane 13” of packet offsets 220 is considered valid. The packet offset 242 is updated to an offset value of 3, since 3 of the 5 sectors are stored in a subsequent data stream. When the packet receiver processes the subsequent data stream, the packet receiver will use the offset value of 3 as the initial packet offset value.

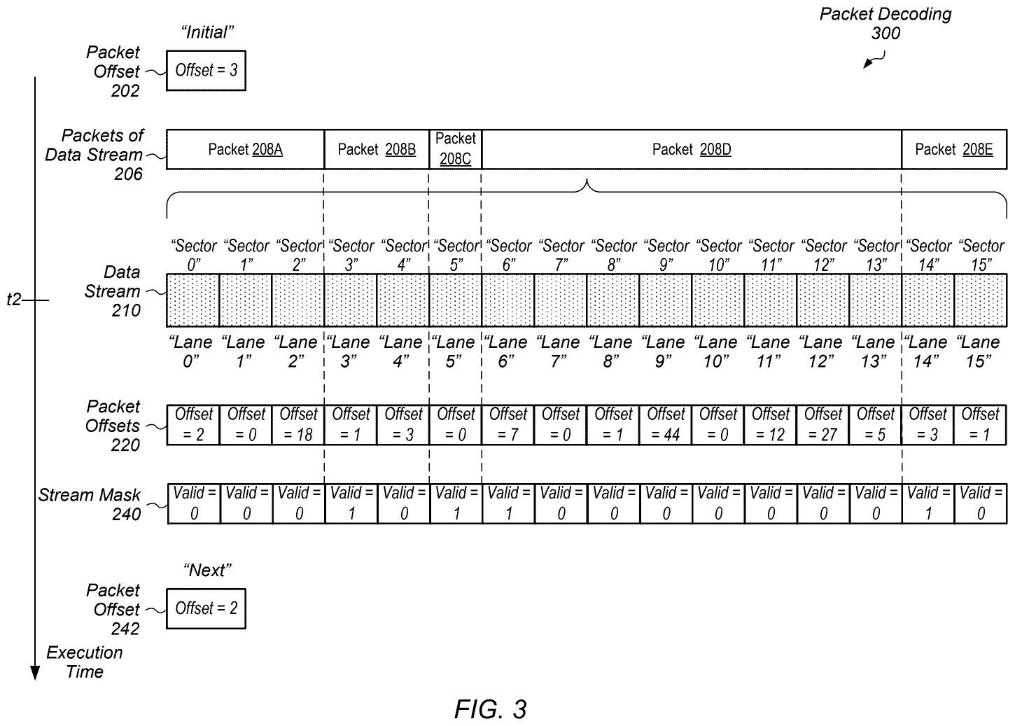

Referring to FIG. 3, a generalized diagram is shown of packet decoding 300 that efficiently performs data decoding in an integrated circuit. Circuitry, components, and data storage elements previously described are numbered identically. As shown, a packet receiver receives at point in time t2 (or time t2) after time t1, packet offset 202 and data stream 210. The packets of data stream 210 are shown as packets of data stream 206. At time t2, packets of data stream 206 includes packets 208A-208E, which store new information compared to packets received at time t1. In the illustrated implementation, the packet receiver processes the subsequent data stream that is a contiguous immediate neighbor data stream to the data stream processed in packet decoding 200 (of FIG. 2). Each of the multiple, parallel lanes of the vector processing circuit generates the indications of offsets in packet offsets 220 concurrently in the same clock cycle in a lockstep manner. The initial packet offset stored as packet offset 202 is updated to an offset value of 3. Therefore, the first three sectors of data stream 210 store packet data of the last packet of the immediately previous data stream.

At time t2, the fourth sector of data stream 210 being processed by “Lane 3” of the vector processing circuit stores the start (or beginning) of another packet in data stream 210. The corresponding fourth bit position (“Lane 3”) of stream mask 240 is written with an asserted bit. The corresponding first bit position (“Lane 0”), the second bit position (“Lane 1”), and third bit position (“Lane 2”) of stream mask 240 are written with a negated bit. The vertical dashed lines indicate the beginnings of packets 208A-208E at time t2. The corresponding packet offset of “1” for “Lane 3” of packet offsets 220 is considered valid. The previously described processing steps continue for the remaining sectors of data stream 210 and the results are shown.

In various implementations, the packet receiver receives data stream 210 and the packet offset 202, because of a processing circuit using the packet receiver is executing a vector decode instruction. In some implementations, the vector decode instruction includes a source operand that includes a pointer or an address, or a vector register identifier (ID) that specifies a data storage location that stores the data stream 210. The vector decode instruction also includes a scalar data input source operand such as packet offset 202. The vector decode instruction also includes a destination operand that includes a pointer or an address, or a vector register ID that specifies a data storage location that stores stream mask 240. The vector decode instruction also includes a scalar data output destination operand such as packet offset 242.

The opcode of the vector decode instruction specifies the data size of the sectors. In an implementation, the vector decode instruction is v_decode_u32 sdst, vdst, vsrc, ssrc. In this implementation, the scalar destination operand “sdst” includes a pointer or an address, or a register ID that specifies a data storage location that stores packet offset 242. The vector destination operand “vdst” includes a pointer or an address, or a vector register ID that specifies a data storage location that stores stream mask 240. The vector source operand “vsrc” includes a pointer or an address, or a vector register ID that specifies a data storage location that stores data stream 210. The scalar source operand “ssrc” includes a pointer or an address, or a vector register ID that specifies a data storage location that stores packet offset 202. In another implementation, two vector decode instructions are used as a pair. The first vector decode instruction receives packet offset 202 and data stream 210 as source operands and generates packet offsets 220 as a vector output. The second vector decode instruction receives packet offset 202 and packet offsets 220 (generated by the first vector decode instruction) as source operands and generates packet offsets 220 as a vector output. from data stream 210, and a second vector decode instruction receives the packet offsets 220 as a vector source operand and generates stream mask 240 and packet offset 242 as outputs.

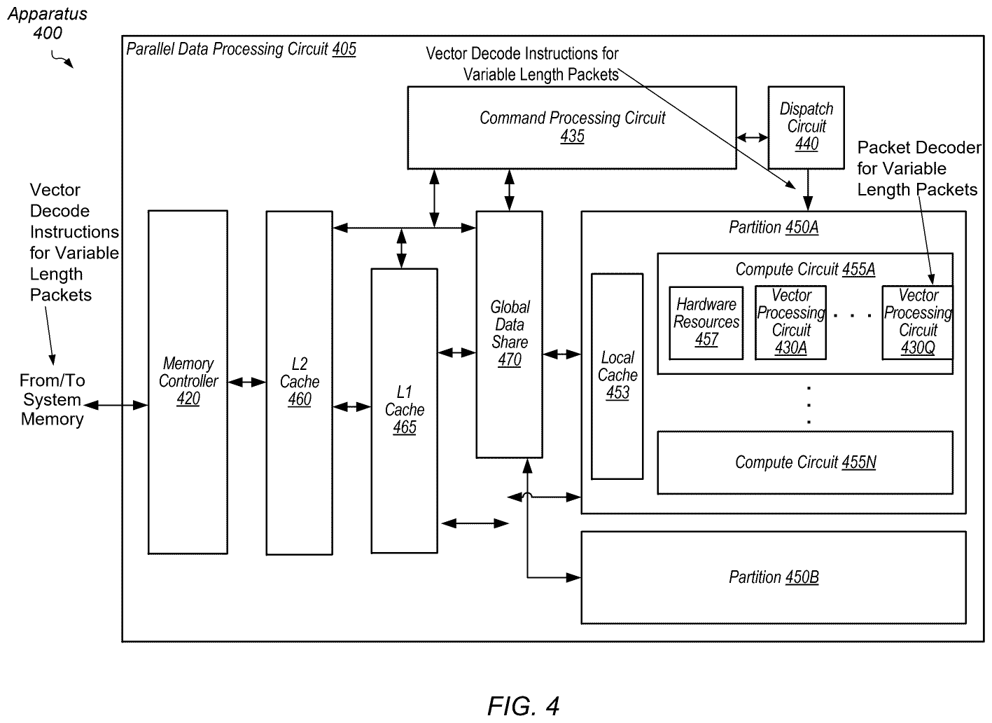

Turning now to FIG. 4, a block diagram is shown of an apparatus 400 that efficiently processes multiplication and accumulate operations for matrices in applications. In one implementation, apparatus 400 includes the parallel data processing circuit 405 with an interface to system memory. In an implementation, the parallel data processing circuit 405 is a graphics processing unit (GPU). In various implementations, apparatus 400 executes any of various types of highly parallel data applications. As part of executing an application, a host CPU (not shown) launches kernels to be executed by the parallel data processing circuit 405. The command processing circuit 435 receives translated commands of kernels from the host CPU and determines when dispatch circuit 440 dispatches wavefronts of these kernels to the compute circuits 455A-455N. These kernels include vector decode instructions, which are translated to vector decode commands to be executed by vector processing circuits 430A-430Q. In various implementations, these vector decode instructions have the format described earlier for packet receiver 100 (of FIG. 1) and packet decoding 200-300 (of FIGS. 2-3).

Multiple processes of a highly parallel data application provide multiple kernels to be executed on the compute circuits 455A-455N. Each kernel corresponds to a function call of the highly parallel data application. The parallel data processing circuit 405 includes at least the command processing circuit (or command processor) 435, dispatch circuit 440, compute circuits 455A-455N, memory controller 420, global data share 470, shared level one (L1) cache 365, and level two (L2) cache 460. It should be understood that the components and connections shown for the parallel data processing circuit 405 are merely representative of one type processing circuit and does not preclude the use of other types of processing circuits for implementing the techniques presented herein. The apparatus 400 also includes other components which are not shown to avoid obscuring the figure. In other implementations, the parallel data processing circuit 405 includes other components, omits one or more of the illustrated components, has multiple instances of a component even if only one instance is shown in the apparatus 400, and/or is organized in other suitable manners. Also, each connection shown in apparatus 400 is representative of any number of connections between components. Additionally, other connections can exist between components even if these connections are not explicitly shown in apparatus 400.

In an implementation, the memory controller 420 directly communicates with each of the partitions 450A-450B and includes circuitry for supporting communication protocols and queues for storing requests and responses. Memory controller 420 receives vector decode instructions used in a parallel data application. Threads within wavefronts executing on compute circuits 455A-455N read data from and write data to the cache 453, vector general-purpose registers, scalar general-purpose registers, and when present, the global data share 470, the shared L1 cache 465, and the L2 cache 460. When present, it is noted that L1 cache 465 can include separate structures for data and instruction caches. It is also noted that global data share 470, shared L1 cache 465, L2 cache 460, memory controller 420, system memory, and cache 552 can collectively be referred to herein as a “cache memory subsystem”.

In various implementations, the circuitry of partition 450B is a replicated instantiation of the circuitry of partition 450A. In some implementations, each of the partitions 450A-450B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, the local cache 453 represents a last level shared cache structure such as a local level-two (L2) cache within partition 450A. Additionally, each of the multiple compute circuits 455A-455N includes vector processing circuits 430A-430Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration.

Each of the vector ALUs within a given row across the lanes includes the same circuitry and functionality, and operates on the same instruction, but different data, such as a different data item, associated with a different thread. In various implementations, the vector ALUs of vector processing circuits 430A-430Q include circuitry that support decoding data streams partitioned into multiple sectors and carrying multiple variable length packets distributed across the multiple sectors. In various implementations, each of the vector processing circuits 430A-430Q has the same functionality as vector processing circuit 130 (of FIG. 1) and performs packet decoding as illustrated in packet decoding 200 and 300 (of FIGS. 2 and 3).

In addition to the vector processing circuits 430A-430Q, the compute circuit 455A also includes the hardware resources 457. The hardware resources 457 include at least an assigned number of vector general-purpose registers (VGPRs) per thread, an assigned number of scalar general-purpose registers (SGPRs) per wavefront, and an assigned data storage space of a local data store per workgroup. Each of the compute circuits 455A-455N receives wavefronts from the dispatch circuit 440 and stores the received wavefronts in a corresponding local dispatch circuit (not shown). A local scheduler within the compute circuits 455A-455N schedules these wavefronts to be dispatched from the local dispatch circuits to the vector processing circuits 430A-430Q. The cache 453 can be a last level shared cache structure of the partition 450A.

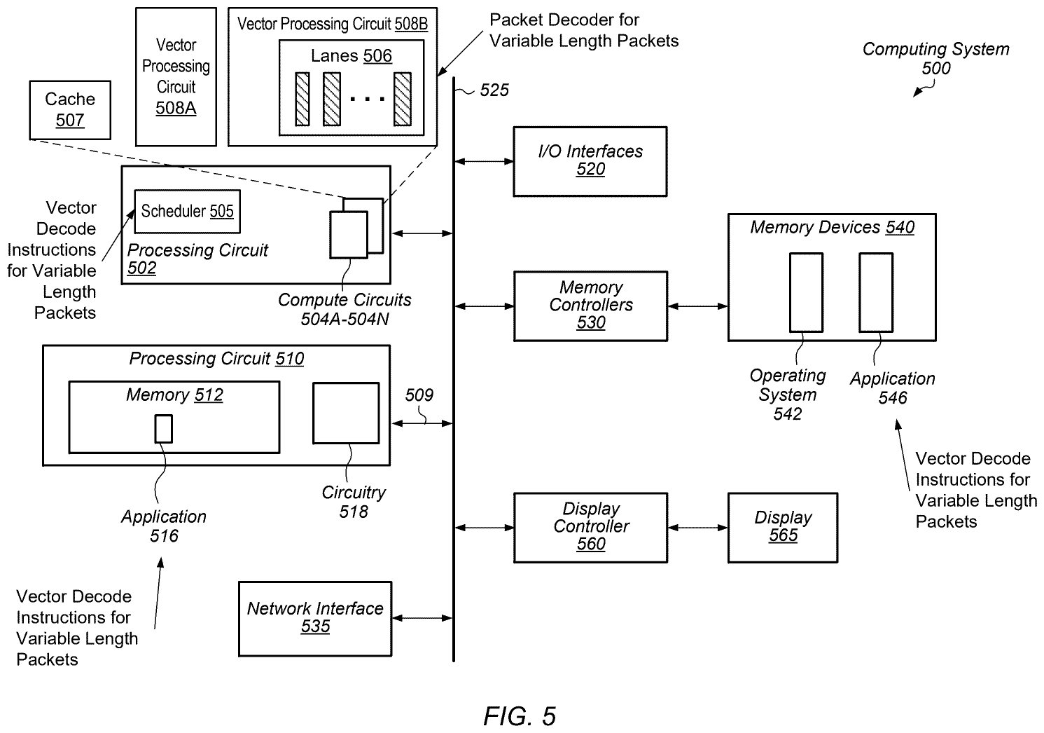

Turning now to FIG. 5, a generalized diagram is shown of a computing system 500 efficiently performs data decoding in an integrated circuit. In an implementation, the computing system 500 includes at least processing circuits 502 and 510, input/output (I/O) interfaces 520, bus 525, network interface 535, memory controllers 530, memory devices 540, display controller 560, and display 565. In other implementations, computing system 500 includes other components and/or computing system 500 is arranged differently. For example, power management circuitry, and phased locked loops (PLLs) or other clock generating circuitry are not shown for ease of illustration. In various implementations, the components of the computing system 500 are on the same die such as a system-on-a-chip (SOC). In other implementations, the components are individual dies in a system-in-package (SiP) or a multi-chip module (MCM). A variety of computing devices use the computing system 500 such as a desktop computer, a laptop computer, a server computer, a tablet computer, a smartphone, a gaming device, a smartwatch, and so on.

Processing circuits 502 and 510 are representative of any number of processing circuits which are included in computing system 500. In an implementation, processing circuit 510 is a general-purpose central processing unit (CPU). In one implementation, processing circuit 502 is a parallel data processing circuit with a highly parallel data microarchitecture, such as a GPU. The processing circuit 502 can be a discrete device, such as a dedicated GPU (dGPU), or the processing circuit 502 can be integrated (an iGPU) in the same package as another processing circuit. Other parallel data processing circuits that can be included in computing system 500 include digital signal processing circuits (DSPs), field programmable gate arrays (FPGAs), application specific integrated circuits (ASICs), and so forth.

In various implementations, the processing circuit 502 includes multiple, replicated compute circuits 504A-504N, each including similar circuitry and components such as the vector processing circuits 508A-508B, the cache 507, and hardware resources (not shown). Vector processing circuit 508A includes replicated circuitry of the circuitry of the vector processing circuit 508B. Although two vector processing circuits are shown, in other implementations, another number of vector processing circuits is used based on design requirements. As shown, vector processing circuit 508B includes multiple, parallel computational lanes 506. In various implementations, each of the multiple, parallel computational lanes 506 has the functionality of lanes 132 (of FIG. 1). In various implementations, each of the vector processing circuits 508A-508B has the same functionality of vector processing circuit 130 (of FIG. 1) and vector processing circuits 430A-430Q (of FIG. 4) and performs packet decoding as illustrated in packet decoding 200 and 300 (of FIGS. 2 and 3).

The hardware of scheduler 505 assigns wavefronts to be dispatched to the compute circuits 504A-504N. In an implementation, scheduler 505 is a command processing circuit of a GPU. In some implementations, the application 546 stored on the memory devices 540 and its copy (application 516) stored on the memory 512 are a highly parallel data application that includes particular function calls using an API to allow the developer to insert a request in the highly parallel data application for launching wavefronts of a kernel (function call). In some implementations, application 546 is a highly parallel data application that provides multiple kernels to be executed on the compute circuits 504A-504N. These kernels include vector decode instructions, which are translated to vector decode commands to be executed by vector processing circuits 430A-430Q. In various implementations, these vector decode instructions have the format described earlier for packet receiver 100 (of FIG. 1) and packet decoding 200-300 (of FIGS. 2-3). Processing circuit 502 uses vector processing circuits 508A-508B to execute the vector decode instructions.

The high parallelism offered by the hardware of the compute circuits 504A-504N is used for real-time data processing. Examples of real-time data processing are rendering multiple pixels, image blending, pixel shading, vertex shading, and geometry shading. In such cases, each of the data items of a wavefront is a pixel of an image. The compute circuits 504A-504N can also be used to execute other threads that require operating simultaneously with a relatively high number of different data elements (or data items). Examples of these threads are threads for scientific, medical, finance and encryption/decryption computations.

Memory 512 represents a local hierarchical cache memory subsystem. Memory 512 stores source data, intermediate results data, results data, and copies of data and instructions stored in memory devices 540. Processing circuit 510 is coupled to bus 525 via interface 509. Processing circuit 510 receives, via interface 509, copies of various data and instructions, such as the operating system 542, one or more device drivers, one or more applications such as application 546, and/or other data and instructions. The processing circuit 510 retrieves a copy of the application 546 from the memory devices 540, and the processing circuit 510 stores this copy as application 516 in memory 512. In some implementations, application 546 (and its copy application 516) includes an instruction that requests a data stream to be decoded in a manner illustrated by in packet decoding 200 and 300 (of FIGS. 2 and 3). Each of the sources that generates the data stream and the destination that uses the data stream processed by one of the vector processing circuits 508A-508B can be any one of the components of computing system 500.

In some implementations, computing system 500 utilizes a communication fabric (“fabric”), rather than the bus 525, for transferring requests, responses, and messages between the processing circuits 502 and 510, the I/O interfaces 520, the memory controllers 530, the network interface 535, and the display controller 560. When messages include requests for obtaining targeted data, the circuitry of interfaces within the components of computing system 500 translates target addresses of requested data. In some implementations, the bus 525, or a fabric, includes circuitry for supporting communication, data transmission, network protocols, address formats, interface signals and synchronous/asynchronous clock domain usage for routing data.

Memory controllers 530 are representative of any number and type of memory controllers accessible by processing circuits 502 and 510. While memory controllers 530 are shown as being separate from processing circuits 502 and 510, it should be understood that this merely represents one possible implementation. In other implementations, one of memory controllers 530 is embedded within one or more of processing circuits 502 and 510 or it is located on the same semiconductor die as one or more of processing circuits 502 and 510. Memory controllers 530 are coupled to any number and type of memory devices 440.

Memory devices 540 are representative of any number and type of memory devices. For example, the type of memory in memory devices 440 includes Dynamic Random Access Memory (DRAM), Static Random Access Memory (SRAM), NAND Flash memory, NOR flash memory, Ferroelectric Random Access Memory (FeRAM), or otherwise. Memory devices 540 store at least instructions of an operating system 542, one or more device drivers, and application 546. In some implementations, application 546 is a highly parallel data application such as a video graphics application, a shader application, or otherwise. Copies of these instructions can be stored in a memory or cache device local to processing circuit 510 and/or processing circuit 502.

I/O interfaces 520 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 520. Such peripheral devices include (but are not limited to) displays, keyboards, mice, printers, scanners, joysticks or other types of game controllers, media recording devices, external storage devices, and so forth. Network interface 135 receives and sends network messages across a network.

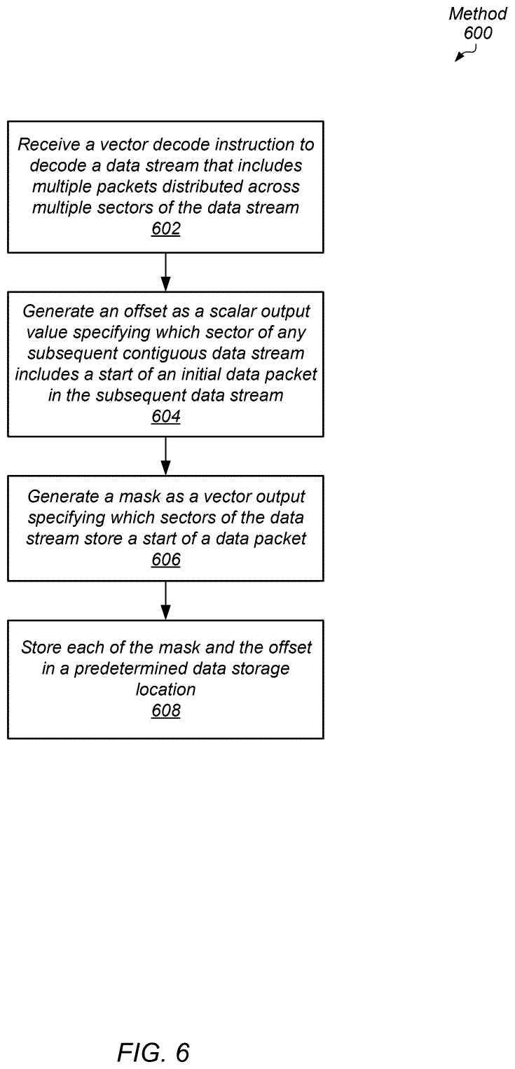

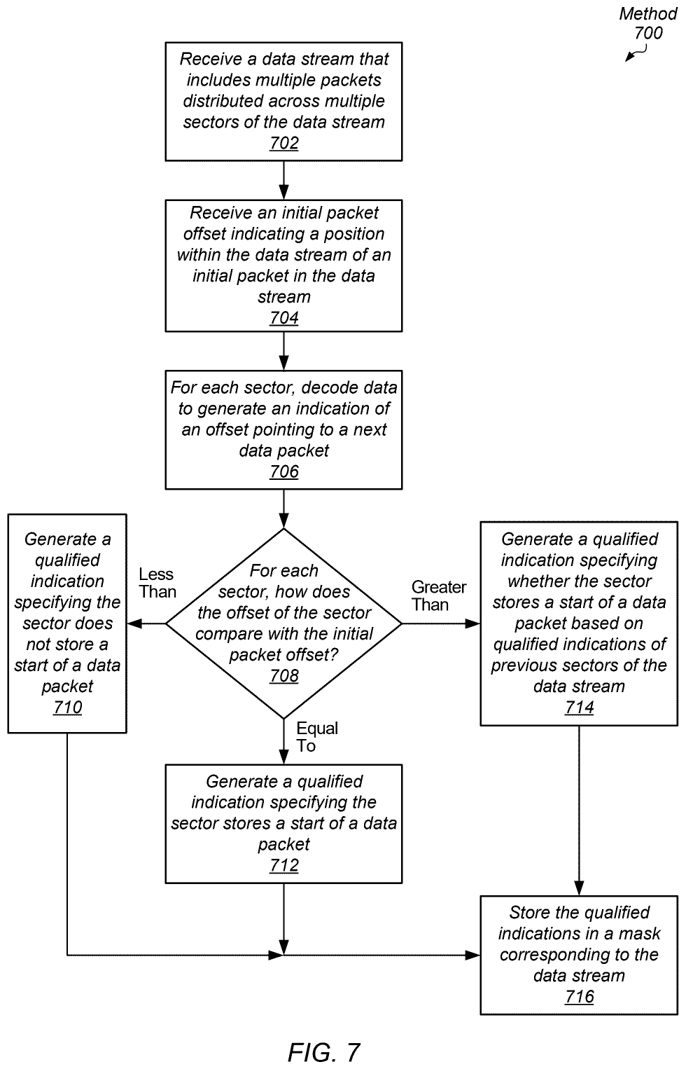

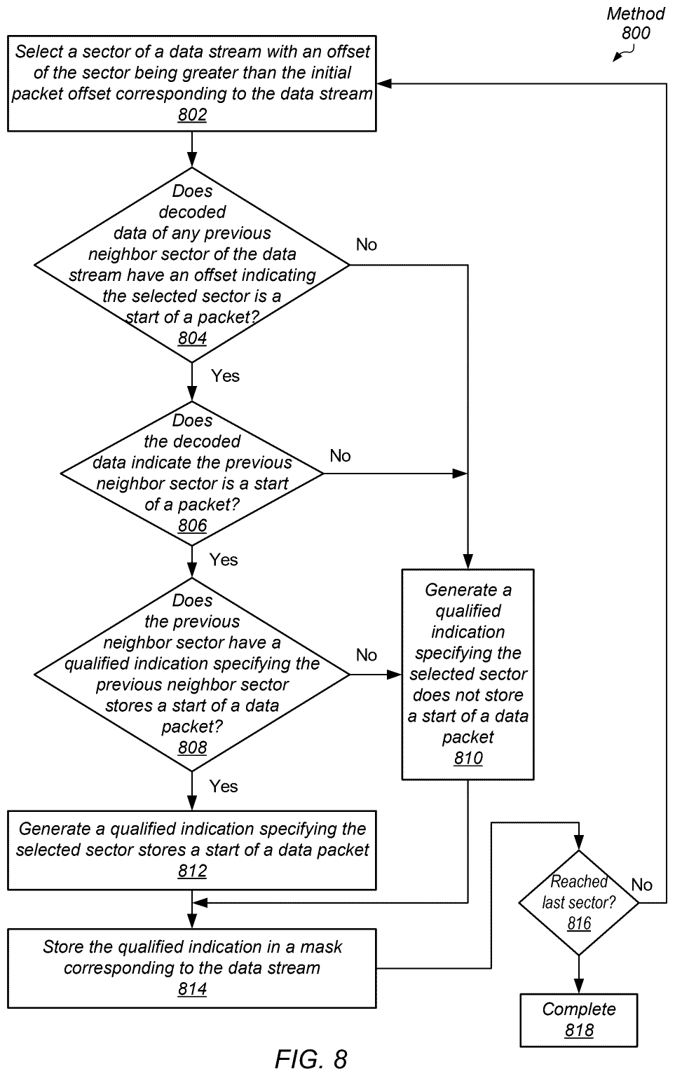

Referring to FIG. 6, a generalized diagram is shown of a method 600 for efficiently performing data decoding in an integrated circuit. For purposes of discussion, the steps in this implementation (as well as in FIGS. 7-8) are shown in sequential order. However, in other implementations some steps occur in a different order than shown, some steps are performed concurrently, some steps are combined with other steps, and some steps are absent.

A processing circuit that uses multiple, parallel lanes of execution receives a vector decode instruction specifying to decode a data stream that includes multiple packets distributed across multiple sectors of the data stream (block 602). In some implementations, the processing circuit has the functionality of processing circuit 502 (of FIG. 5) and includes one or more vector processing circuits. The vector decode instruction is included in the instructions of a kernel (function call). In various implementations, these vector decode instructions have the format described earlier for packet receiver 100 (of FIG. 1) and packet decoding 200-300 (of FIGS. 2-3). The vector decode instruction is used to perform parallel decoding of the data stream. Parallel decoding reduces the latency of processing the data stream, which increases performance. The processing circuit generates an offset as a scalar output value specifying which sector of any subsequent contiguous data stream includes a start of an initial data packet in the subsequent data stream (block 604). In some implementations, this offset is a value similar to packet offset 202 (of FIGS. 2-3). The processing circuit generates a mask as a vector output value specifying which sectors of the data stream store the start of a data packet (block 606). In some implementations, this mask is a value similar to stream mask 240 (of FIGS. 2-3). The asserted bits within this bit mask indicate the number of variable length data packets within the data stream and the locations of the variable length data packets within the data streams. The mask supports parallel data processing for the next stage of data processing of the application using the vector decode instruction. The processing circuit stores each of the mask and the offset in a predetermined data storage location (block 608).

Referring to FIG. 7, a generalized diagram is shown of a method 700 for efficiently performing data decoding in an integrated circuit. A processing circuit that uses multiple, parallel lanes of execution receives a data stream that includes multiple packets distributed across multiple sectors of the data stream a data stream that includes multiple packets distributed across multiple sectors of the data stream (block 702). The processing circuit receives an initial packet offset indicating a position within the data stream of an initial packet in the data stream (block 704). For each sector, the processing circuit decodes data to generate an indication of an offset pointing to the start of the next data packet in the data stream (block 706).

For each sector, the processing circuit generates an indication specifying how the offset of the sector compares with the initial packet offset. If the processing circuit generates an indication specifying the offset of the sector being less than the initial packet offset (“less than” branch of the conditional block 708), then the processing circuit generates an indication specifying the sector does not store a start of a data packet (block 710). If the processing circuit generates an indication specifying the offset of the sector being equal to the initial packet offset (“equal to” branch of the conditional block 708), then the processing circuit generates an indication specifying the sector stores a start of a data packet (block 712). If the processing circuit generates an indication specifying the offset of the sector being greater than the initial packet offset (“greater than” branch of the conditional block 708), then the processing circuit generates an indication specifying whether the sector stores a start of a data packet based on indications of previous sectors of the data stream (block 714). Further details of these steps are provided in the description of method 800 (of FIG. 8). Afterward, the processing circuit stores the indications in a mask corresponding to the data stream (block 716).

Referring to FIG. 8, a generalized diagram is shown of a method 800 for efficiently performing data decoding in an integrated circuit. A processing circuit that uses multiple, parallel lanes of execution selects a sector of a data stream with an offset of the sector being greater than the initial packet offset corresponding to the data stream (block 802). If the processing circuit generates an indication specifying decoded data of no previous neighbor sector of the data stream has an offset indicating the selected sector is a start of a packet (“no” branch of the conditional block 804), then the processing circuit generates an indication specifying the selected sector does not store a start of a data packet (block 810). If the processing circuit generates an indication specifying decoded data of any previous neighbor sector of the data stream has an offset indicating the selected sector is a start of a packet (“yes” branch of the conditional block 804), but the processing circuit generates an indication specifying the decoded data does not indicate the previous neighbor sector is a start of a packet (“no” branch of the conditional block 806), then control flow of method 800 moves to block 810 where the processing circuit generates an indication specifying the selected sector does not store a start of a data packet.

If the processing circuit generates an indication specifying decoded data of any previous neighbor sector of the data stream has an offset indicating the selected sector is a start of a packet (“yes” branch of the conditional block 804), and the processing circuit generates an indication specifying the decoded data indicates the previous neighbor sector is a start of a packet (“yes” branch of the conditional block 806), but the processing circuit generates an indication specifying the previous neighbor sector does not have an indication specifying the previous neighbor sector stores a start of a data packet (“no” branch of the conditional block 808), then control flow of method 800 moves to block 810 where the processing circuit generates an indication specifying the selected sector does not store a start of a data packet. It is noted that the processing circuit evaluates the conditional blocks 804 and 806 concurrently, since separate lanes of execution perform the evaluations simultaneously. However, the processing circuit evaluates the conditional block 808 serially after the parallel decoding steps.

If the processing circuit generates an indication specifying decoded data of any previous neighbor sector of the data stream has an offset indicating the selected sector is a start of a packet (“yes” branch of the conditional block 804), and the processing circuit generates an indication specifying the decoded data indicates the previous neighbor sector is a start of a packet (“yes” branch of the conditional block 806), and the processing circuit generates an indication specifying the previous neighbor sector has an indication specifying the previous neighbor sector stores a start of a data packet (“yes” branch of the conditional block 808), then the processing circuit generates an indication specifying the selected sector stores a start of a data packet (block 812). The processing circuit stores the indication in a mask corresponding to the data stream (block 814). If the last sector has not yet been reached (“no” branch of the conditional block 816), then control flow of method 800 returns to block 802 where the processing circuit selects another sector of the data stream with the offset of the sector being greater than the initial packet offset corresponding to the data stream Statement one says this stuff (block 816). If the last sector has been reached (“yes” branch of the conditional block 816), then the processing circuit has completed evaluating the sectors (block 818).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of execution lanes, each comprising circuitry to execute instructions; and
circuitry configured to:
receive a first data stream comprising a plurality of packets, wherein the first data stream is partitioned into a plurality of sectors, each with a same size;
assign each of the plurality of sectors to a corresponding one of the plurality of execution lanes;
generate an offset for each of the plurality of sectors that specifies a subsequent sector that stores a start of a packet of the plurality of packets; and
generate a mask specifying which sectors of the plurality of sectors store a start of a data packet.

2. The apparatus as recited in claim 1, wherein the circuitry is further configured to receive an initial packet offset indicating a sector of the plurality of sectors that stores an initial packet of the plurality of packets in the first data stream.

3. The apparatus as recited in claim 2, wherein the circuitry is further configured to:
generate an indication specifying a sector of the plurality of sectors does not store a start of a data packet, responsive to an offset of the sector is less than the initial packet offset; and
generate an indication specifying a sector of the plurality of sectors stores a start of a data packet, responsive to an offset of the sector is equal to the initial packet offset.

4. The apparatus as recited in claim 2, wherein the circuitry is further configured to generate an indication specifying whether the sector stores a start of a data packet based on indications of previous sectors of the plurality of sectors, responsive to an offset of the sector is greater than the initial packet offset.

5. The apparatus as recited in in claim 2, wherein the circuitry is further configured to generate a next offset specifying which sector of a subsequent contiguous data stream includes a start of an initial data packet in the subsequent contiguous data stream.

6. The apparatus as recited in claim 1, wherein to generate an offset of a given sector of the plurality of sectors, the circuitry is further configured to:
parse the given sector into one or more fields and convert one of the one or more fields into a data size of a corresponding packet of the plurality of packets; and
generate a ratio of the data size and the same size of each of the plurality of sectors.

7. The apparatus as recited in claim 1, wherein the circuitry is further configured to generate the mask responsive to receiving a vector decode instruction that specifies a size of each of the plurality of sectors and a data storage location storing the first data stream.

8. A method, comprising:
receiving, by circuitry of a parallel data processing circuit, a first data stream comprising a plurality of packets, wherein the first data stream is partitioned into a plurality of sectors, each with a same size;
assigning, by the circuitry, each of the plurality of sectors to a corresponding one of a plurality of execution lanes;
generating, by the circuitry, an offset for each of the plurality of sectors that specifies a subsequent sector that stores a start of a packet of the plurality of packets; and
generating, by the circuitry, a mask specifying which sectors of the plurality of sectors store a start of a data packet.

9. The method as recited in claim 8, further comprising receiving, by the circuitry, an initial packet offset indicating a sector of the plurality of sectors that stores an initial packet of the plurality of packets in the first data stream.

10. The method as recited in claim 9, further comprising:
generating, by the circuitry, an indication specifying a sector of the plurality of sectors does not store a start of a data packet, responsive to an offset of the sector is less than the initial packet offset; and
generating, by the circuitry, an indication specifying a sector of the plurality of sectors stores a start of a data packet, responsive to an offset of the sector is equal to the initial packet offset.

11. The method as recited in claim 9, further comprising generating, by the circuitry, an indication specifying whether the sector stores a start of a data packet based on indications of previous sectors of the plurality of sectors, responsive to an offset of the sector is greater than the initial packet offset.

12. The method as recited in claim 9, further comprising generating, by the circuitry, a next offset specifying which sector of a subsequent contiguous data stream includes a start of an initial data packet in the subsequent contiguous data stream.

13. The method as recited in claim 8, wherein to generate an offset of a given sector of the plurality of sectors, the method further comprises:
parsing the given sector into one or more fields and convert one of the one or more fields into a data size of a corresponding packet of the plurality of packets; and
generating a ratio of the data size and the same size of each of the plurality of sectors.

14. The method as recited in claim 8, further comprising generating the mask responsive to receiving a vector decode instruction that specifies a size of each of the plurality of sectors and a data storage location storing the first data stream.

15. A computing system comprising:
a memory; and
a vector processing circuit comprising:
a plurality of execution lanes, each comprising circuitry to execute instructions; and
circuitry; and
wherein the circuitry is configured to:
receive a first data stream comprising a plurality of packets, wherein the first data stream is partitioned into a plurality of sectors, each with a same size;
assign each of the plurality of sectors to a corresponding one of the plurality of execution lanes;
generate an offset for each of the plurality of sectors that specifies a subsequent sector that stores a start of a packet of the plurality of packets; and
generate a mask specifying which sectors of the plurality of sectors store a start of a data packet.

16. The computing system as recited in claim 15, wherein the circuitry is further configured to receive an initial packet offset indicating a sector of the plurality of sectors that stores an initial packet of the plurality of packets in the first data stream.

17. The computing system as recited in claim 16, wherein the circuitry is further configured to:
generate an indication specifying a sector of the plurality of sectors does not store a start of a data packet, responsive to an offset of the sector is less than the initial packet offset; and
generate an indication specifying a sector of the plurality of sectors stores a start of a data packet, responsive to an offset of the sector is equal to the initial packet offset.

18. The computing system as recited in claim 16, wherein the circuitry is further configured to generate an indication specifying whether the sector stores a start of a data packet based on indications of previous sectors of the plurality of sectors, responsive to an offset of the sector is greater than the initial packet offset.

19. The computing system as recited in claim 16, wherein the circuitry is further configured to generate a next offset specifying which sector of a subsequent contiguous data stream includes a start of an initial data packet in the subsequent contiguous data stream.

20. The computing system as recited in claim 15, wherein to generate an offset of a given sector of the plurality of sectors, the circuitry is further configured to:
parse the given sector into one or more fields and convert one of the one or more fields into a data size of a corresponding packet of the plurality of packets; and
generate a ratio of the data size and the same size of each of the plurality of sectors.
